(19) United States
(12) Patent Application Publication
(10) Pub. No.: US 2026/0295502 A1
(43) Pub. Date: Oct. 1, 2026

(54) DAC APPARATUS

(71) Applicant: Honda Motor Co., Ltd., Tokyo (JP)

(72) Inventors: Hiroka Shigi, Saitama (JP); Masayuki Sadakiyo, Saitama (JP); Toshiyuki Inaba, Saitama (JP); Keisuke Shimizu, Saitama (JP)

(21) Appl. No.: 19/575,757

(22) Filed: Mar. 23, 2026

(30) Foreign Application Priority Data
Mar. 28, 2025 (JP) 2025-055211

(51) Int. Cl. B01D 53/04

(52) U.S. Cl. CPC B01D 53/0454; B01D 53/0438; B01D 2257/504

(57) ABSTRACT

A DAC apparatus to recover CO₂ in the atmosphere, includes: an adsorption chamber provided with an adsorbent for adsorbing or absorbing CO₂; an atmospheric control valve to open the adsorption chamber to the atmosphere or seal the adsorption chamber; a vacuum pump connected with the adsorption chamber through vacuum piping; a vacuum control valve provided on the vacuum piping; a heating device to heat the adsorbent; a pressure sensor to detect pressure of the adsorption chamber; and a controller to control the atmospheric control valve, vacuum control valve, vacuum pump, and heating device to alternately perform an adsorption step and desorption step. The controller controls the atmospheric control valve, vacuum control valve, and vacuum pump to depressurize the adsorption chamber when starting the desorption step, and then determines whether the atmospheric control valve is normal based on pressure detected before heating the adsorbent.

### CROSS-REFERENCE TO RELATED APPLICATION

This application is based upon and claims the benefit of priority from Japanese Patent Application No. 2025-055211 filed on March 28, 2025, the content of which is incorporated herein by reference.

### BACKGROUND OF THE INVENTION

### Field of the Invention

The present invention relates to a direct air capture (DAC) apparatus that recovers carbon dioxide (CO₂) in the atmosphere.

### Description of the Related Art

For the purpose of mitigating climate changes, research and development have been conducted on DAC technology for recovering CO₂, which is a main greenhouse gas. As such a DAC technology, an apparatus that recovers CO₂ in the atmosphere using an adsorbent for adsorbing or absorbing CO₂is known. For example, in the apparatus of JP 2024-048937 A, after the atmosphere is circulated into an adsorption chamber in which an adsorbent is provided to adsorb CO₂ in the atmosphere to the adsorbent, the inside of the adsorption chamber is depressurized using a vacuum pump to desorb CO₂from the adsorbent. Thus, a desorption gas having a high CO₂ concentration is recovered, and in addition, in a case where the pressure rise in the adsorption chamber while in desorption exceeds a reference, it is determined that there is a pressure leakage from the adsorption chamber.

However, by merely determining presence or absence of the pressure leakage, based on the pressure in the adsorption chamber while in desorption as in the apparatus described in JP 2024-048937 A, it is difficult to prevent the adsorbent from being exposed to the atmosphere while the temperature is rising, and the adsorbent may be subject to oxidation deterioration.

### SUMMARY OF THE INVENTION

An aspect of the present invention is a DAC apparatus configured to recover CO₂ in the atmosphere, including: an adsorption chamber provided with an adsorbent for adsorbing or absorbing CO₂; an atmospheric control valve configured to open the adsorption chamber to the atmosphere or seal the adsorption chamber from the atmosphere; a vacuum pump connected with the adsorption chamber through vacuum piping; a vacuum control valve provided on the vacuum piping; a heating device configured to heat the adsorbent; a pressure sensor configured to detect a pressure of the adsorption chamber; and a controller configured to control the atmospheric control valve, the vacuum control valve, the vacuum pump, and the heating device to alternately perform an adsorption step and a desorption step, the adsorption step circulating the atmosphere into the adsorption chamber and adsorbing CO₂in the atmosphere to the adsorbent, the desorption step depressurizing the adsorption chamber, heating the adsorbent, and desorbing CO₂from the adsorbent. The controller controls the atmospheric control valve, the vacuum control valve, and the vacuum pump to depressurize the adsorption chamber when starting the desorption step, and then determines whether the atmospheric control valve is normal based on the pressure detected by the pressure sensor before heating the adsorbent.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of a piping configuration of a DAC apparatus according to an embodiment of the present invention;

FIG. 2 is a block diagram schematically illustrating an example of a control configuration of the DAC apparatus according to the embodiment of the present invention;

FIG. 3 is a time chart for describing an operation schedule of the DAC apparatus;

FIG. 4 is a time chart for describing changes in pressure and temperature in each step;

FIG. 5 is a flowchart illustrating an example of failure detection processing in an adsorption step performed by a controller shown in FIG. 2;

FIG. 6 is a flowchart illustrating an example of the failure detection processing in a deaeration step performed by the controller shown in FIG. 2;

FIG. 7 is a flowchart illustrating an example of the failure detection processing in a desorption step performed by the controller shown in FIG. 2;

FIG. 8 is a diagram for describing a failure state in S37 of FIG. 7;

FIG. 9A is a diagram for describing a situation that leads to a failure state in S39 of FIG. 7;

FIG. 9B is a diagram for describing the failure state in S39 of FIG. 7;

FIG. 10 is a flowchart illustrating an example of the failure detection processing in a cooling and pressure-recovering step performed by the controller shown in FIG. 2;

FIG. 11 is a flowchart illustrating an example of a first FSA processing performed by the controller shown in FIG. 2;

FIG. 12 is a flowchart illustrating an example of a second FSA processing performed by the controller shown in FIG. 2;

FIG. 13 is a flowchart illustrating an example of a third FSA processing performed by the controller shown in FIG. 2; and

FIG. 14 is a diagram for describing a pressure-recovering processing in S82 to S84 of FIG. 13.

### DETAILED DESCRIPTION OF THE INVENTION

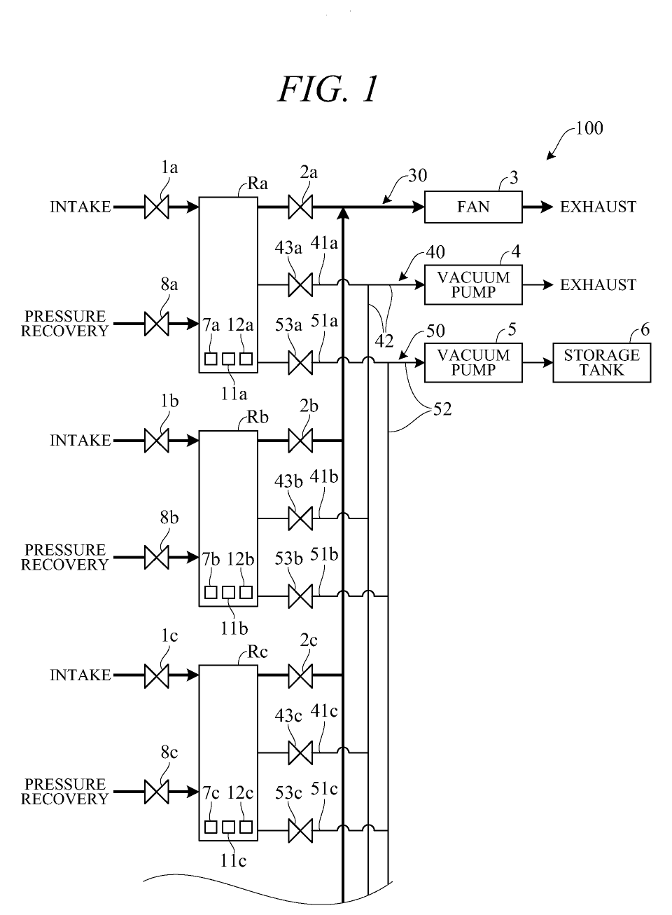

Hereinafter, embodiments of the present invention will be described with reference to FIGS. 1 to 14. FIG. 1 is a block diagram schematically illustrating an example of a piping configuration of a DAC apparatus 100 according to an embodiment of the present invention. As illustrated in FIG. 1, the DAC apparatus 100 mainly includes a plurality of reactors R (Ra, Rb, Rc, and so on) in each of which an adsorbent for adsorbing or absorbing CO₂ is provided.

The reactor R includes a housing in which a sealed space (an adsorption chamber) can be formed, and an adsorbent is provided in the adsorption chamber of the reactor R. As the adsorbent, a solid material composed to adsorb CO₂ at normal temperature and normal pressure and to desorb CO₂as the temperature rises can be used. For example, an amine-based solid absorbent in which an amine-based compound is carried on an appropriate carrier can be used. The adsorbent is constituted in an appropriate granular shape, is filled in a filter cartridge or the like having a mesh structure, for example, and is accommodated in the adsorption chamber of the reactor R.

Atmospheric control valves 1 (1a, 1b, 1c, and so on) and 2 (2a, 2b, 2c, and so on), which open the reactor R to the atmosphere or seal the reactor R from the atmosphere, are provided for the reactor R. The atmospheric control valves 1 and 2 may be provided on piping that connects the adsorption chamber of the reactor R with an external space, or may be provided as a part of a housing (a wall surface) of the reactor R. When the atmospheric control valves 1 and 2 are opened, the adsorption chamber of the reactor R is opened to the atmosphere. When the atmospheric control valves 1 and 2 are closed, the adsorption chamber of the reactor R is sealed. The atmospheric control valve 1 and the atmospheric control valve 2 are provided to face each other with the adsorption chamber interposed between them.

A fan 3 for circulating the atmosphere into the adsorption chamber of the reactor R is connected with the reactor R through appropriate piping (atmospheric piping) 30 and one of the atmospheric control valves 1 and 2 (the atmospheric control valve 2 in the illustrated example). In the illustrated example, when the atmospheric control valves 1 and 2 are open and the fan 3 is driven, the atmosphere is taken into the reactor R through the atmospheric control valve 1, and the atmosphere is exhausted from the reactor R through the atmospheric control valve 2, the atmospheric piping 30, and the fan 3. Thus, when the atmosphere circulates into the reactor R, CO₂ in the atmosphere is adsorbed to the adsorbent in the adsorption chamber (an adsorption step). The atmospheric control valves 1 and 2 and the atmospheric piping 30 are each configured to have a relatively large diameter so as to enable a large amount of atmosphere to circulate into the reactor R. A plurality of atmospheric control valves 1 and a plurality of atmospheric control valves 2 may be provided.

Vacuum piping 40 is further connected with the reactor R. The vacuum piping 40 connects the adsorption chamber of the reactor R with an intake port of a vacuum pump 4. More specifically, the vacuum piping 40 includes: individual piping 41 (41a, 41b, 41c, and so on), which communicates with the adsorption chamber of each reactor R; and junction piping 42, which joins the individual piping 41 to communicate with the intake port of the vacuum pump 4, and thus connects the individual piping 41 with the vacuum pump 4.

On each individual piping 41, a vacuum control valve 43 (43a, 43b, 43c, and so on), which permits or prohibits the flow of gas in the individual piping 41, that is, the flow from the reactor R to the vacuum piping 40, is provided. The vacuum control valve 43 may be made up of an on-off valve such as a ball valve, may be made up of an adjustment valve such as a butterfly valve, or may be made up of a combination of them.

When the adsorption step ends, the atmospheric control valves 1 and 2 are closed, and in addition, the vacuum control valve 43 is opened. The gas in the adsorption chamber of the reactor R is sucked out by the vacuum pump 4 through the vacuum piping 40, and is exhausted. Thus, the residual atmosphere in the adsorption chamber of the reactor R, more specifically, the gas that is not adsorbed to the adsorbent such as oxygen is deaerated, and the inside of the adsorption chamber of the reactor R is depressurized from normal pressure (atmospheric pressure) to the final ultimate pressure of the vacuum pump 4 (a deaeration step).

Vacuum piping 50 is further connected with the reactor R. The vacuum piping 50 connects the adsorption chamber of the reactor R with an intake port of a vacuum pump 5. A storage tank 6 is connected with an exhaust port of the vacuum pump 5 through appropriate piping. More specifically, the vacuum piping 50 includes: individual piping 51 (51a, 51b, 51c, and so on), which communicates with the adsorption chamber of each reactor R; and junction piping 52, which joins the individual piping 51 to communicate with the intake port of the vacuum pump 5, and thus connects the individual piping 51 with the vacuum pump 5.

On each piece of the individual piping 51, a vacuum control valve 53 (53a, 53b, 53c, and so on), which permits or prohibits the flow of gas in the individual piping 51, that is, the flow from the reactor R to the vacuum piping 50, is provided. Similarly to the vacuum control valve 43, the vacuum control valve 53 may be made up of an on-off valve such as a ball valve, may be made up of an adjustment valve such as a butterfly valve, or may be made up of a combination of them.

In the reactor R, furthermore, a heating device that heats the adsorbent and a cooling device that cools the adsorbent are provided. For example, a heat exchanger 7 (7a, 7b, 7c, and so on), which heats or cools the adsorbent, is provided.

When the deaeration step ends, the atmospheric control valves 1 and 2 and the vacuum control valve 43 are closed, and in addition, the vacuum control valve 53 is opened. The adsorbent in the adsorption chamber is heated by the heat exchanger 7, and the gas in the adsorption chamber of the reactor R is sucked out by the vacuum pump 5 through the vacuum piping 50. Thus, CO₂ that has been adsorbed to the adsorbent of the reactor R is desorbed, and the desorption gas mainly containing the desorbed CO₂ is sucked out of the reactor R, is stored in the storage tank 6, and is recovered. In addition, the inside of the adsorption chamber is maintained to be closer to the final ultimate pressure of the vacuum pump 5 (a desorption step).

Furthermore, a pressure recovery control valve 8 (8a, 8b, 8c, and so on), which recovers the pressure in the adsorption chamber of the reactor R, is provided for the reactor R. The pressure recovery control valve 8 may be provided on piping that connects the adsorption chamber of the reactor R with an external space, or may be provided directly on a housing (a wall surface) of the reactor R.

When the desorption step ends, the atmospheric control valves 1 and 2, the vacuum control valves 43 and 53, and the pressure recovery control valve 8 are closed, and the adsorbent in the adsorption chamber is cooled by the heat exchanger 7 (a cooling step). When the adsorbent is cooled down to normal temperature, the pressure recovery control valve 8 is opened, and the atmosphere is introduced into the adsorption chamber of the reactor R from the external space. Thus, the pressure in the adsorption chamber is recovered to the atmospheric pressure (a pressure-recovering step).

In a case where the adsorbent is heated in the desorption step, if the adsorbent becomes a high temperature in a state in which oxygen is present in the adsorption chamber, the adsorbent may be subject to oxidation deterioration. In the deaeration step, the residual atmosphere containing oxygen is deaerated, and then the desorption step accompanied with a temperature rise of the adsorbent is started. In addition, after the desorption step, the adsorbent is cooled in the cooling step, and the atmosphere is introduced into the adsorption chamber in the pressure-recovering step. Thus, it becomes possible to prevent oxidation deterioration of the adsorbent. In the present embodiment, the DAC apparatus 100 is configured as follows in such a manner that a failure of the vacuum system including the control valves 1, 2, 43, 53, and 8 is detected, and an appropriate fail-safe action (FSA) is taken as necessary so that the oxidation deterioration of the adsorbent can be prevented.

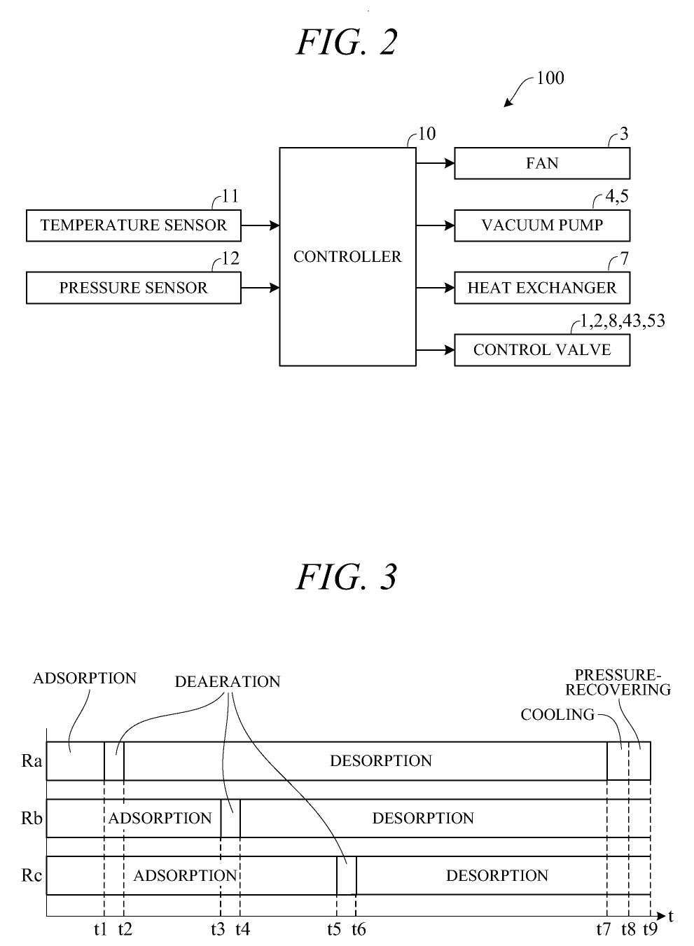

FIG. 2 is a block diagram schematically illustrating an example of a control configuration of the DAC apparatus 100. As illustrated in FIG. 2, the DAC apparatus 100 includes a controller 10, which controls each unit of the DAC apparatus 100. The controller 10 is made up of a computer including a CPU, a ROM, a RAM, an I/O interface, and other peripheral circuits.

As illustrated in FIGS. 1 and 2, a temperature sensor 11 (11a, 11b, 11c, and so on), which detects a temperature T of the adsorbent of the reactor R, and a pressure sensor 12 (12a, 12b, 12c, and so on), which detects pressure P in the adsorption chamber of the reactor R, are provided in the reactor R. As illustrated in FIG. 2, the temperature sensor 11 and the pressure sensor 12 are connected with the controller 10, and signals indicating detection values of the temperature sensor 11 and the pressure sensor 12 are respectively input into the controller 10. In addition, each unit of the DAC apparatus 100, which includes the fan 3, the vacuum pumps 4 and 5, the heat exchanger 7, and the control valves 1, 2, 8, 43, and 53, is connected with the controller 10, and a control signal is transmitted from the controller 10 to each unit of the DAC apparatus 100.

The controller 10 drives the fan 3 and the vacuum pumps 4 and 5, and activates the heat exchanger 7, and then controls the respective units of the DAC apparatus 100 so that the adsorption step, the deaeration step, the desorption step, the cooling step, and the pressure-recovering step are sequentially performed in each reactor R in accordance with a predetermined operation schedule.

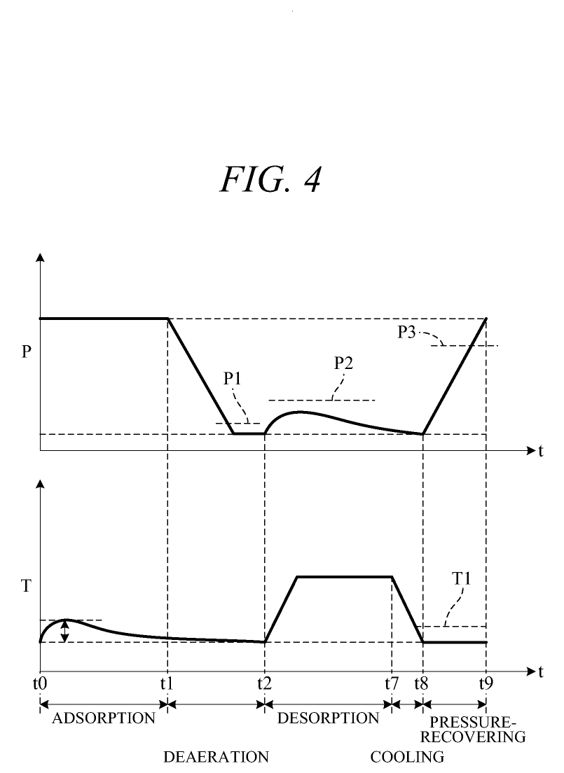

FIG. 3 is a time chart for describing an operation schedule of the DAC apparatus 100. As illustrated in FIG. 3, in the predetermined operation schedule, the adsorption step, the deaeration step, the desorption step, the cooling step, and the pressure-recovering step are sequentially performed in the plurality of reactors R by shifting the timing. In the example of FIG. 3, the adsorption step of the reactor Ra ends and the deaeration step is started at time t1, the deaeration step of the reactor Ra ends and the desorption step is started at time t2, the adsorption step of the reactor Rb ends and the deaeration step is started at time t3, the deaeration step of the reactor Rb ends and the desorption step is started at time t4, the adsorption step of the reactor Rc ends and the deaeration step is started at time t5, the deaeration step of the reactor Rc ends and the desorption step is started at time t6, the desorption step of the reactor Ra ends and the cooling step is started at time t7, the cooling step of the reactor Ra ends and the pressure-recovering step is started at time t8, and the pressure-recovering step of the reactor Ra ends at time t9.

In the adsorption step, the controller 10 controls and closes the pressure recovery control valve 8 and the vacuum control valves 43 and 53 and opens the atmospheric control valves 1 and 2. The controller 10 also controls the heat exchanger 7 not to heat or cool the adsorbent. Thus, the atmosphere circulates into the reactor R, and CO₂ in the atmosphere is adsorbed to the adsorbent at normal temperature.

In the deaeration step, the controller 10 controls and closes the atmospheric control valves 1 and 2, the pressure recovery control valve 8, and the vacuum control valve 53 and opens the vacuum control valve 43. The controller 10 also controls the heat exchanger 7 not to heat or cool the adsorbent. Thus, the residual atmosphere in the adsorption chamber of the reactor R is deaerated.

In the desorption step, the controller 10 controls and closes the atmospheric control valves 1 and 2, the pressure recovery control valve 8, and the vacuum control valve 43 and opens the vacuum control valve 53. The controller 10 also controls the heat exchanger 7 to heat the adsorbent. Thus, CO₂ is desorbed from the adsorbent of the reactor R, and is recovered.

In the cooling step, the controller 10 controls and closes the atmospheric control valves 1 and 2, the pressure recovery control valve 8, and the vacuum control valves 43 and 53, and also controls the heat exchanger 7 to cool the adsorbent. Thus, the adsorbent of the reactor R is cooled down to normal temperature.

In the pressure-recovering step, the controller 10 controls and closes the atmospheric control valves 1 and 2 and the vacuum control valves 43 and 53 and opens the pressure recovery control valve 8. The controller 10 also controls the heat exchanger 7 not to heat the adsorbent. Thus, the pressure in the adsorption chamber of the reactor R is recovered to the atmospheric pressure.

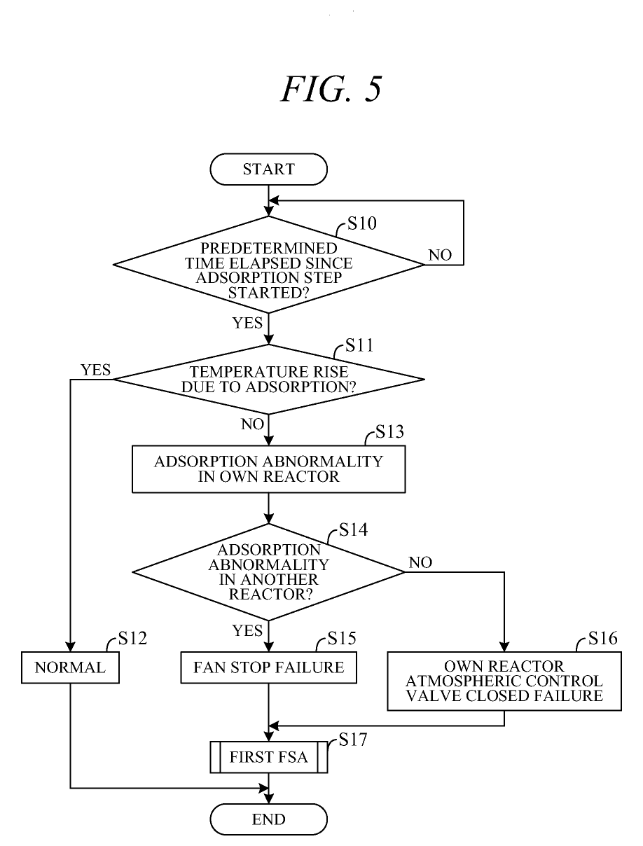

FIG. 4 is a time chart for describing changes in the pressure P of the reactor R (the reactor Ra in FIG. 3) and the temperature T of the adsorbent in each step. As illustrated in FIG. 4, in the adsorption step from time t0 to time t1, the pressure P of the reactor R is maintained at atmospheric pressure, and the temperature T of the adsorbent is maintained at normal temperature, and is increased by the amount of adsorption heat in accordance with an adsorption amount. Immediately after the adsorption step starts, the adsorption amount is relatively large, and the temperature rises relatively largely. In the deaeration step from time t1 to time t2, the pressure P of the reactor R decreases to the final ultimate pressure of the vacuum pump 4, and the temperature T of the adsorbent is maintained at normal temperature. In the desorption step from time t2 to time t7, the pressure P of the reactor R is maintained near the final ultimate pressure of the vacuum pump 5, and increases in accordance with a desorption amount, and the temperature T of the adsorbent increases to the desorption temperature of CO₂. In the former half of the desorption step, the desorption amount is relatively large, and the pressure rises relatively largely. In the cooling step from time t7 to time t8, the pressure P of the reactor R is maintained at the final ultimate pressure of the vacuum pump 5, and the temperature T of the adsorbent decreases to normal temperature. In the pressure-recovering step from time t8 to time t9, the pressure P of the reactor R rises to atmospheric pressure, and the temperature T of the adsorbent is maintained at normal temperature.

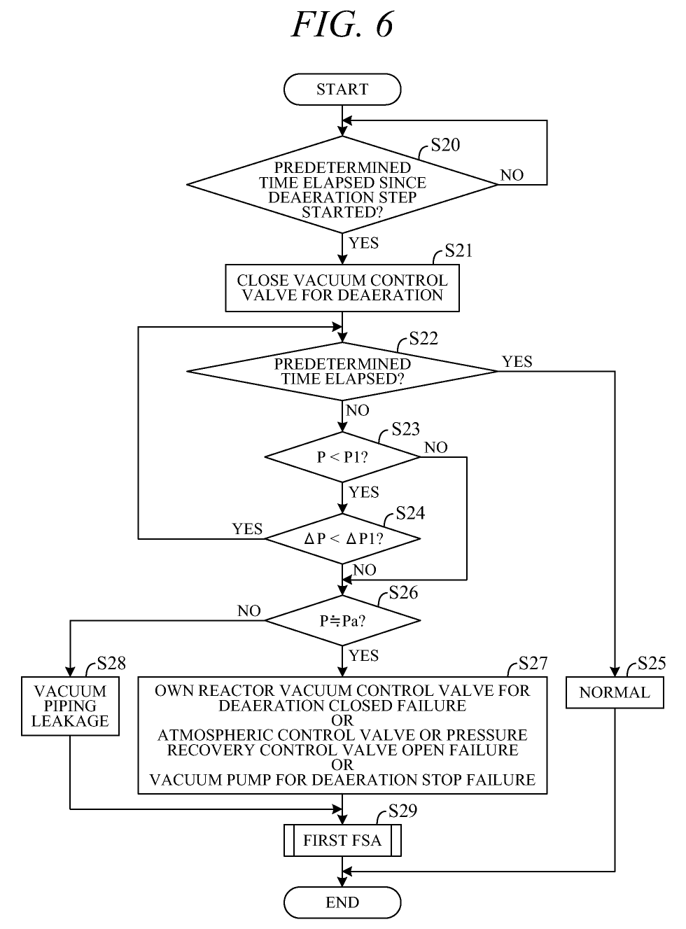

FIG. 5 is a flowchart illustrating an example of failure detection processing in the adsorption step performed by the controller 10. The failure detection processing is performed for each reactor R. Hereinafter, a target reactor R of the failure detection processing will be referred to as an own reactor Rs, and another reactor will be referred to as “another reactor Ro”, in some cases. As illustrated in FIG. 5, in the failure detection processing in the adsorption step, the controller 10 first determines whether a predetermined time has elapsed since the adsorption step started in the own reactor Rs in S10 (S: processing step). As illustrated in FIG. 4, the predetermined time in this case corresponds to a period of time from when the adsorption step starts to when the temperature rise corresponding to the adsorption heat becomes the maximum, and is determined beforehand by experiment.

The predetermined time has elapsed since the adsorption step started, and in a case where the affirmative determination is made in S10, the processing proceeds to S11, and it is determined whether the temperature has risen to correspond to the adsorption heat, based on the temperature T, which has been detected by the temperature sensor 11 of the own reactor Rs, since the adsorption step started. In a case where the affirmative determination is made in S11, the processing proceeds to S12, and it is determined that the adsorption step in the own reactor Rs has been normally performed. In this case, it can be said that the atmospheric control valves 1 and 2 of the own reactor Rs are normally opened, and the fan 3 is normally operating.

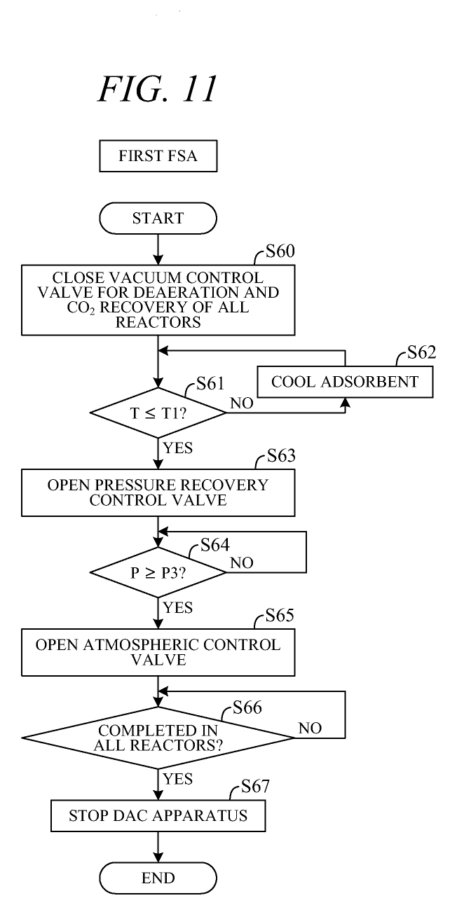

On the other hand, in a case where a negative determination is made in S11, the processing proceeds to S13, and it is determined that some abnormality (adsorption abnormality) related to the adsorption step is occurring in the own reactor Rs. Next, in S14, it is determined whether the adsorption abnormality is occurring also in another reactor Ro. In a case where the adsorption abnormality is occurring in both the own reactor Rs and another reactor Ro, an affirmative determination is made in S14, the processing proceeds to S15, and it is determined that the fan 3 is not normally operating (a stop failure). On the other hand, in a case where an adsorption abnormality is occurring only in the own reactor Rs, a negative determination is made in S14, the processing proceeds to S16, and it is determined that the atmospheric control valves 1 and 2 of the own reactor Rs are not normally opened (closed failure). In a case where it is determined that the fan 3 has the stop failure in S15 and in a case where it is determined that the atmospheric control valves 1 and/or 2 have the closed failure in S16, the processing proceeds to S17, and a first FSA (FIG. 11) is taken.

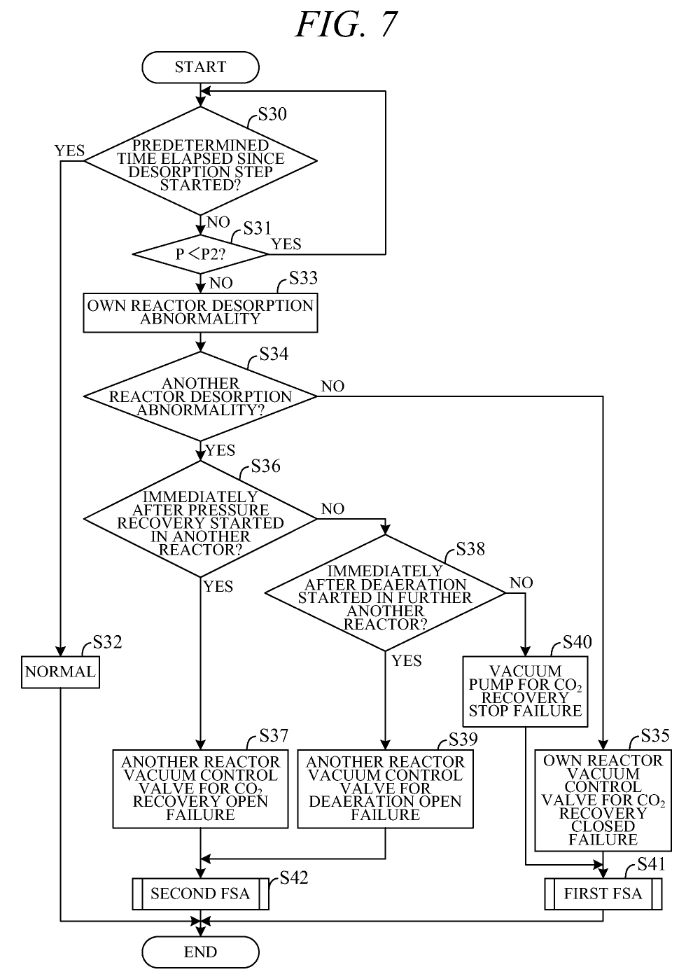

FIG. 6 is a flowchart illustrating an example of the failure detection processing in the deaeration step performed by the controller 10. As illustrated in FIG. 6, in the failure detection processing in the deaeration step, the controller 10 first determines in S20 whether a predetermined time has elapsed since the deaeration step started in the own reactor Rs. As illustrated in FIG. 4, the predetermined time in this case corresponds to a period of time necessary for the pressure P of the reactor R to decrease from the atmospheric pressure to the final ultimate pressure of the vacuum pump 4, and is determined beforehand by experiment. S20 is repeated until an affirmative determination is made.

The predetermined time has elapsed since the deaeration step started, and in a case where the affirmative determination is made in S20, the processing proceeds to S21, the vacuum control valve 43, which is open for deaeration, is controlled to be closed, and the deaeration of the own reactor Rs ends. Next, in S22, it is determined whether a predetermined time has elapsed since the vacuum control valve 43 was closed and the deaeration ended. The predetermined time in this case is determined beforehand as the time for confirming that the pressure P of the reactor R is maintained in a depressurized state by the vacuum pump 4 for deaeration. Immediately after the deaeration ends, a negative determination is made in S22, and the processing proceeds to S23.

In S23, it is determined whether the pressure P, which has been detected by the pressure sensor 12 of the own reactor Rs, is lower than predetermined pressure P1. The predetermined pressure P1 is determined beforehand as a pressure threshold for confirming that the pressure P of the reactor R is appropriately reduced, and is set to the pressure slightly higher than the final ultimate pressure of the vacuum pump 4 as illustrated in FIG. 4. In a case where an affirmative determination is made in S23, the processing proceeds to S24, and it is determined whether a pressure change ΔP after the vacuum control valve 43 is closed and the deaeration ends is lower than a predetermined value ΔP1. In a case where the pressure change ΔP is smaller, an affirmative determination is made in S24, and the processing returns to S22.

When a state in which the pressure change ΔP after the deaeration ends is smaller than the predetermined value ΔP1 continues for a predetermined period of time, an affirmative determination is made in S22, the processing proceeds to S25, and it is determined that the deaeration step in the own reactor Rs has been normally performed. In this case, it can be said that the atmospheric control valves 1 and 2 and the pressure recovery control valve 8 of the own reactor Rs are normally closed, the vacuum control valve 43 for deaeration is normally opened, the vacuum pump 4 is normally operating, and there is no leakage from the vacuum piping 40.

On the other hand, in a case where a negative determination is made in S23 or S24, the processing proceeds to S26, and it is determined whether the pressure P of the own reactor Rs is approximately the atmospheric pressure Pa. In a case where the pressure P of the own reactor Rs is approximately the atmospheric pressure Pa, an affirmative determination is made in S26, the processing proceeds to S27, and it is determined that the vacuum control valve 43 for deaeration of the own reactor Rs is not normally opened (the closed failure), the atmospheric control valves 1 and 2 or the pressure recovery control valve 8 is not normally closed (an open failure), or the vacuum pump 4 for deaeration is not normally operating (the stop failure). On the other hand, in a case where the pressure P of the own reactor Rs is not approximately the atmospheric pressure Pa, a negative determination is made in S26, the processing proceeds to S28, and it is determined that there is a leakage from the vacuum piping 40.

In a case where it is determined in S27 that the vacuum control valve 43 has the closed failure, the atmospheric control valves 1 and 2 or the pressure recovery control valve 8 has the open failure, or the vacuum pump 4 has the stop failure, and in a case where it is determined in S28 that there is a leakage from the vacuum piping 40, the processing proceeds to S29, and the first FSA (FIG. 11) is taken.

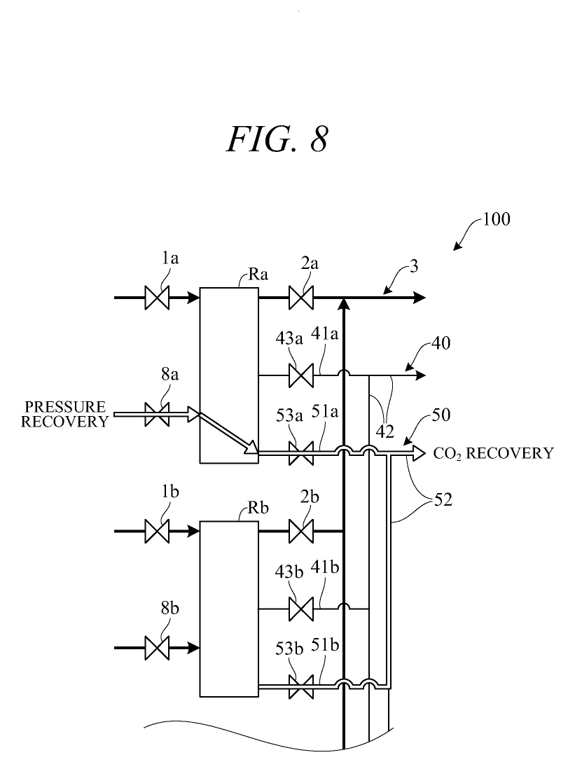

FIG. 7 is a flowchart illustrating an example of the failure detection processing in the desorption step performed by the controller 10. As illustrated in FIG. 7, in the failure detection processing in the desorption step, the controller 10 first determines in S30 whether a predetermined time, which is a duration time of the desorption step on the operation schedule, has elapsed since the desorption step started in the own reactor Rs. Immediately after the desorption step starts, a negative determination is made in S30, and the processing proceeds to S31.

In S31, it is determined whether the pressure P that has been detected by the pressure sensor 12 of the own reactor Rs is lower than predetermined pressure P2. The predetermined pressure P2 is determined beforehand by experiment as a pressure threshold for confirming that the pressure P of the reactor R is appropriately reduced. As illustrated in FIG. 4, the predetermined pressure P2 is set to the pressure sufficiently higher than the final ultimate pressure of the vacuum pump 5 in consideration of the pressure rise in the former half of the desorption step in which the desorption amount is large. In a case where an affirmative determination is made in S31, the processing returns to S30.

When a state in which the pressure P is lower than the predetermined pressure P2 continues for a predetermined period of time, an affirmative determination is made in S30, the processing proceeds to S32, and it is determined that the desorption step in the own reactor Rs has been normally performed. In this case, it can be said that the vacuum control valve 53 for CO₂recovery of the own reactor Rs is normally opened, the vacuum pump 5 is normally operating, and there is no inflow of the gas from another reactor Ro in the pressure-recovering step or the deaeration step.

On the other hand, in a case where a negative determination is made in S31, the processing proceeds to S33, and it is determined that some abnormality (a desorption abnormality) related to the desorption step is occurring in the own reactor Rs. Next, in S34, it is determined whether the desorption abnormality is occurring also in another reactor Ro. In a case where the desorption abnormality is occurring only in the own reactor Rs, a negative determination is made in S34, the processing proceeds to S35, and it is determined that the vacuum control valve 53 for CO₂recovery in the own reactor Rs is not normally opened (the closed failure).

On the other hand, in a case where the desorption abnormality is occurring in both the own reactor Rs and another reactor Ro, an affirmative determination is made in S34, the processing proceeds to S36, and it is determined whether it is immediately after the pressure recovery is started in another reactor Ro. In a case where it is immediately after the pressure recovery is started in another reactor Ro, an affirmative determination is made in S36, the processing proceeds to S37, and it is determined that the vacuum control valve 53 for CO₂ recovery in another reactor Ro is not normally closed (the open failure).

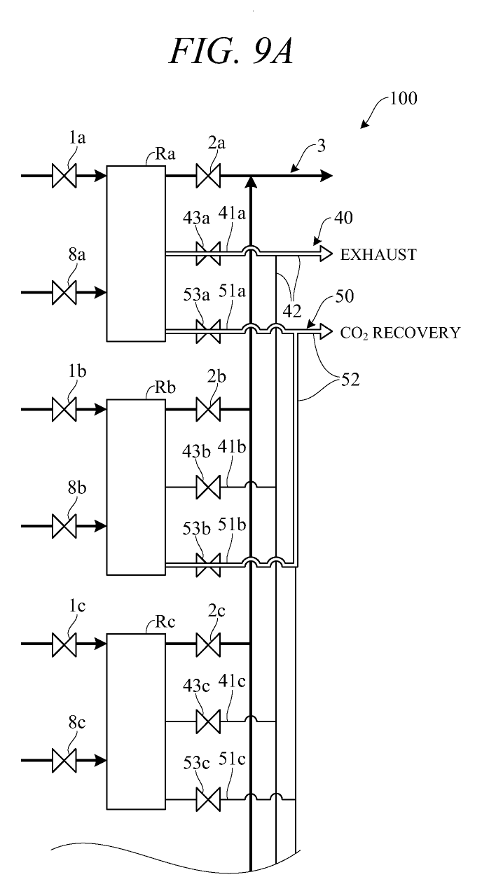

FIG. 8 is a diagram for describing a failure state in S37. In FIG. 8, the reactor Ra represents another reactor Ro in which the desorption step is started earlier and the desorption abnormality is occurring, and the reactor Rb represents the own reactor Rs in which the desorption step is started and the desorption abnormality is occurring while the desorption step is performing in the reactor Ra.

As illustrated in FIG. 8, when the vacuum control valve 53a of the reactor Ra has the open failure, it is determined in the failure detection processing (S32 to S33) of the reactor Ra that the desorption abnormality is occurring, and in addition, the gas flows into the vacuum piping 50 at the time of pressure recovery. More specifically, the atmosphere that has flowed into the reactor Ra from the pressure recovery control valve 8a flows into the vacuum piping 50 through the vacuum control valve 53a having the open failure. In this case, as the pressure of the vacuum piping 50 increases, the pressure P detected by the pressure sensor 12b of the reactor Rb in the desorption step increases, and it is determined in the failure detection processing (S32 to S33) of the reactor Rb that the desorption abnormality is occurring. That is, in the failure detection processing (S37) of the reactor Rb as the own reactor Rs, it is determined that the vacuum control valve 53a of the reactor Ra as another reactor Ro has the open failure.

On the other hand, in a case where it is not immediately after the pressure recovery is started in another reactor Ro, a negative determination is made in S36, the processing proceeds to S38, and it is determined in S36 to S37 whether it is immediately after the deaeration is started in further another reactor Ro (hereinafter, another reactor Ro2), which is different from another reactor Ro (hereinafter, another reactor Ro1). In a case where it is immediately after the deaeration is started in another reactor Ro2, an affirmative determination is made in S38, the processing proceeds to S39, and it is determined that the vacuum control valve 43 for deaeration of another reactor Ro1 is not normally closed (the open failure). On the other hand, in a case where it is not immediately after the deaeration is started in another reactor Ro2, a negative determination is made in S38, the processing proceeds to S40, and it is determined that the vacuum pump 5 for CO₂ recovery is not normally operating (the stop failure).

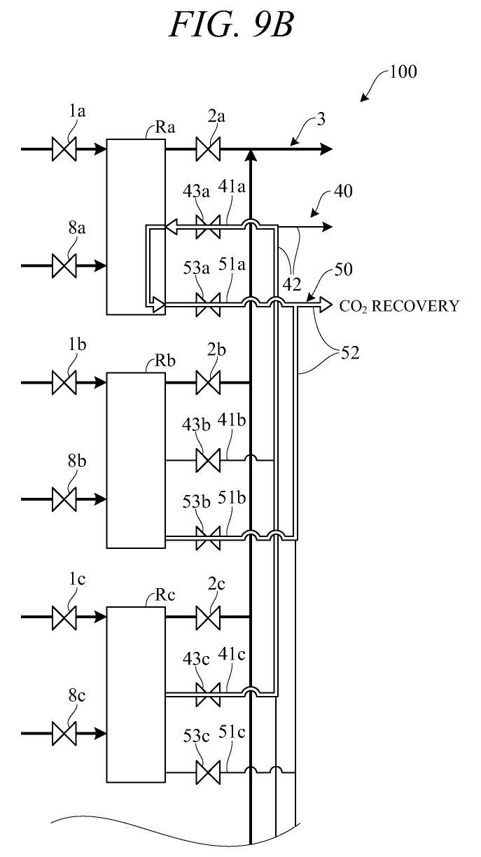

FIG. 9A is a diagram for describing a situation that leads to a failure state in S39, and FIG. 9B is a diagram for describing the failure state in S39. In FIGS. 9A and 9B, the reactor Ra represents another reactor Ro1 in which the desorption step is started earlier and the desorption abnormality is occurring. The reactor Rb represents the own reactor Rs in which the desorption step is started and the desorption abnormality is occurring while the desorption step is being performed in the reactor Ra. The reactor Rc represents another reactor Ro2 in which the deaeration step is started and then the desorption step is started while the desorption step is being performed in the reactor Rb.

As illustrated in FIG. 9A, even though the vacuum control valve 43a for deaeration of the reactor Ra has the open failure, the reactor Ra is depressurized by the vacuum pumps 4 and 5. Therefore, it is not determined that a desorption abnormality is occurring in the failure detection processing (S32 to S33) of the reactor Ra until the deaeration of the reactor Rc is started. As illustrated in FIG. 9B, when the deaeration of the reactor Rc is started, the gas flows from the reactor Rc into the vacuum piping 40 and the vacuum piping 50. More specifically, the residual atmosphere that has flowed from the reactor Rc into the vacuum piping 40 flows into the reactor Ra through the vacuum control valve 43a for deaeration in which the open failure is occurring. In this case, the pressure P detected by the pressure sensor 12a of the reactor Ra in the desorption step increases, and it is determined in the failure detection processing (S32 to S33) of the reactor Ra that the desorption abnormality is occurring.

The residual atmosphere that has flowed into the reactor Ra from the reactor Rc further flows into the vacuum piping 50 from the reactor Ra through the vacuum control valve 53a for CO₂recovery. In this case, as the pressure of the vacuum piping 50 increases, the pressure P detected by the pressure sensor 12b of the reactor Rb in the desorption step increases, and it is determined in the failure detection processing (S32 to S33) of the reactor Rb that the desorption abnormality is occurring. That is, in the failure detection processing (S39) of the reactor Rb as the own reactor Rs, it is determined that the vacuum control valve 43a of the reactor Ra as another reactor Ro1 has the open failure.

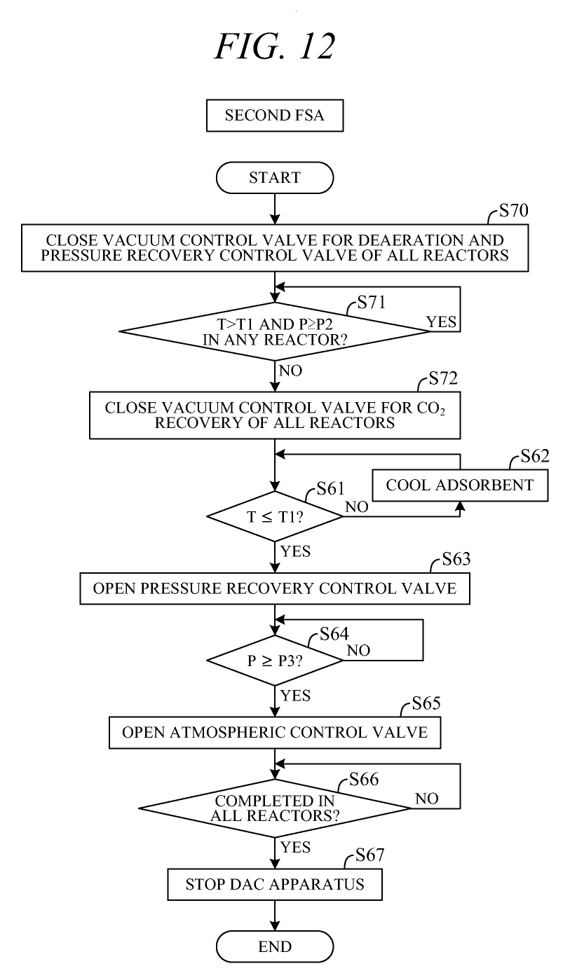

In a case where the closed failure of the vacuum control valve 53 is determined in S35 and in a case where the stop failure of the vacuum pump 5 is determined in S40, the processing proceeds to S41, and the first FSA (FIG. 11) is taken. In a case where it is determined that the vacuum control valve 53 has the open failure in S37 and in a case where it is determined that the vacuum control valve 43 has the open failure in S39, the processing proceeds to S42, and a second FSA (FIG. 12) is taken.

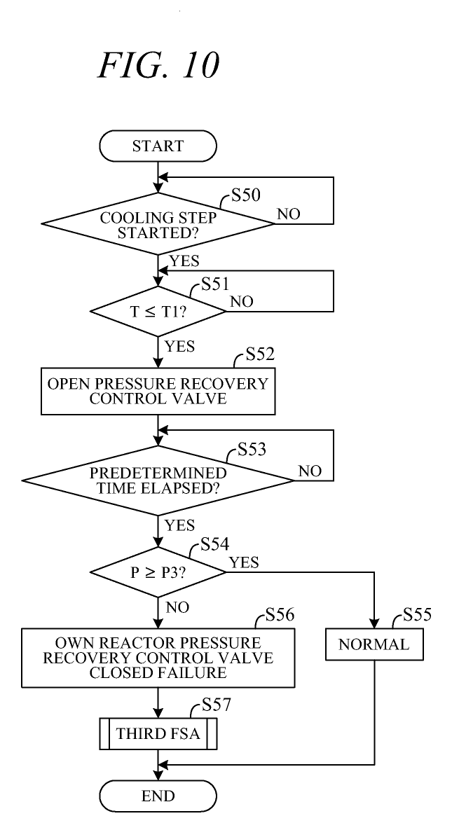

FIG. 10 is a flowchart illustrating an example of the failure detection processing in a cooling and pressure-recovering step performed by the controller 10. As illustrated in FIG. 10, in the failure detection processing in the cooling and pressure-recovering step, the controller 10 first determines in S50 whether the cooling step has been started in the own reactor Rs. S50 is repeated until an affirmative determination is made. The cooling step is started, and in a case where the affirmative determination is made in S50, the processing proceeds to S51, and it is determined whether the temperature T that has been detected by the temperature sensor 11 of the own reactor Rs is equal to or lower than a predetermined temperature T1. The predetermined temperature T1 is determined beforehand as a temperature threshold for confirming that the temperature T of the adsorbent is cooled down to normal temperature, and is set to a temperature slightly higher than the normal temperature as illustrated in FIG. 4. S51 is also repeated until an affirmative determination is made.

In a case where the temperature T decreases to be equal to or lower than the predetermined temperature T1, the affirmative determination is made in S51, and the processing proceeds to S52. The pressure recovery control valve 8 is controlled to be opened, and the pressure recovery of the own reactor Rs is started. Next, in S53, it is determined whether a predetermined time has elapsed since the pressure recovery control valve 8 was opened and the pressure recovery was started. As illustrated in FIG. 4, the predetermined time in this case corresponds to a period of time from when the pressure recovery is started to when the pressure in the adsorption chamber of the reactor R is recovered to the atmospheric pressure, and is determined beforehand by experiment. S53 is also repeated until an affirmative determination is made.

In a case where the predetermined time has elapsed since the pressure recovery started, the affirmative determination is made in S53, the processing proceeds to S54, and it is determined whether the pressure P that has been detected by the pressure sensor 12 of the own reactor Rs is equal to or higher than predetermined pressure P3. The predetermined pressure P3 is determined beforehand by experiment as a pressure threshold for confirming that the pressure in the adsorption chamber of the reactor R is recovered to the atmospheric pressure, and is set to pressure slightly lower than the atmospheric pressure as illustrated in FIG. 4.

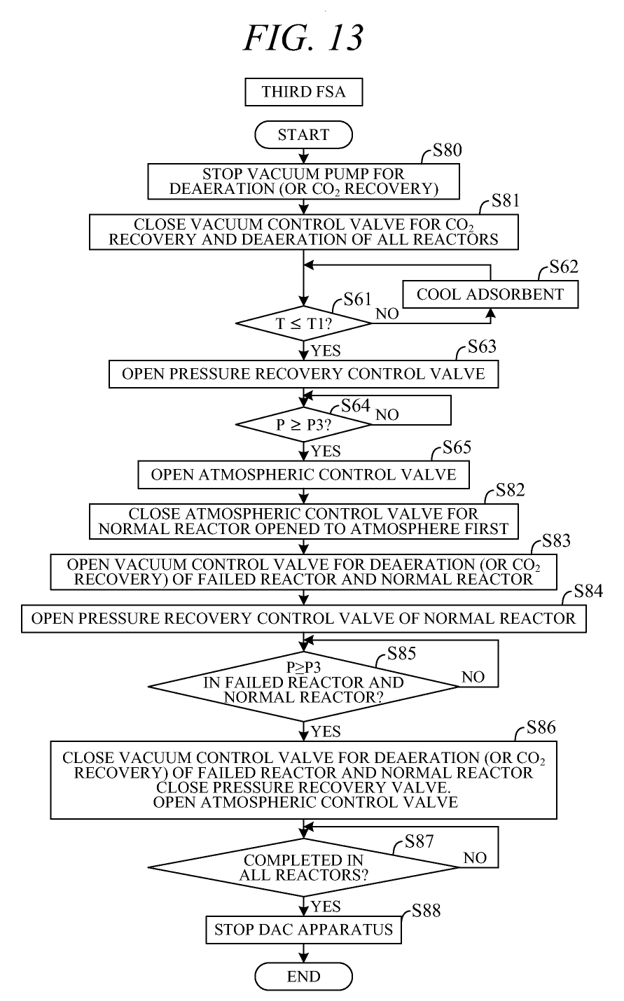

In a case where the pressure P is equal to or higher than the predetermined pressure P3, an affirmative determination is made in S54, the processing proceeds to S55, and it is determined that the pressure-recovering step in the own reactor Rs is normally performed. The pressure recovery control valve 8 is controlled to be closed. In this case, it can be said that the pressure recovery control valve 8 of the own reactor Rs has been normally opened. On the other hand, in a case where the pressure P is lower than the predetermined pressure P3, a negative determination is made in S54, the processing proceeds to S56, and it is determined that the pressure recovery control valve 8 of the own reactor Rs is not normally opened (the closed failure). In a case where it is determined in S56 that the pressure recovery control valve 8 has the closed failure, the processing proceeds to S57, and a third FSA (FIG. 13) is taken.

FIG. 11 is a flowchart illustrating an example of the first FSA processing performed by the controller 10. The first FSA is taken, in a case where the closed failure of the atmospheric control valves 1 and/or 2 or the stop failure of the fan 3 is detected in the adsorption step, in a case where the open failure of the atmospheric control valves 1 and/or 2 or the pressure recovery control valve 8, the closed failure of the vacuum control valve 43, the stop failure of the vacuum pump 4, or a leakage from the vacuum piping 40 is detected in the deaeration step, and in a case where the closed failure of the vacuum control valve 53 or the stop failure of the vacuum pump 5 is detected in the desorption step.

As illustrated in FIG. 11, in the first FSA processing, first, in step S60, the controller 10 controls and closes the vacuum control valves 43 for deaeration and the vacuum control valves 53 for CO₂recovery of all the reactors R. Next, in S61, it is determined whether the temperature T that has been detected by the temperature sensor 11 of each reactor R is equal to or lower than the predetermined temperature T1. For the reactor R having the temperature T that exceeds the predetermined temperature T1, a negative determination is made in S61, the processing proceeds to S62, the heat exchanger 7 is controlled to cool the adsorbent, and the processing returns to S61.

For the reactor R in which the adsorbent has normal temperature and the temperature T is equal to or lower than the predetermined temperature T1, an affirmative determination is made in S61, the processing proceeds to S63, and the pressure recovery control valve 8 is controlled to be opened. Next, in S64, it is determined whether the pressure P that has been detected by the pressure sensor 12 of each reactor R is equal to or higher than the predetermined pressure P3. S64 is repeated until an affirmative determination is made.

The pressure of the reactor R is recovered, and in a case where the pressure P is equal to or higher than the predetermined pressure P3, an affirmative determination is made in S64, the processing proceeds to S65, and the atmospheric control valves 1 and 2 are controlled to be opened. Next, in S66, it is determined whether the processing of S65 has been completed in all the reactors R. S66 is repeated until an affirmative determination is made. In a case where the affirmative determination is made in S66, the processing proceeds to S67, the fan 3, the vacuum pumps 4 and 5, and the heat exchanger 7 are stopped, and the DAC apparatus 100 is stopped.

FIG. 12 is a flowchart illustrating an example of the second FSA processing performed by the controller 10. The second FSA is taken when the open failure of the vacuum control valves 43 and 53 is detected in the desorption step.

As illustrated in FIG. 12, in the second FSA processing, the controller 10 first, in S70, controls and closes the vacuum control valves 43 for deaeration and the pressure recovery control valves 8 of all the reactors R. In this case, with regard to the reactor R in which the adsorbent has a high temperature in the desorption step, the pressure in the adsorption chamber is continuously reduced by the vacuum pump 5 through the vacuum control valve 53 for CO₂recovery. Next, in S71, it is determined whether there is a reactor R in which the temperature T that has been detected by the temperature sensor 11 exceeds the predetermined temperature T1 and the pressure P that has been detected by the pressure sensor 12 is equal to or higher than the predetermined pressure P2. S71 is repeated until a negative determination is made.

In a case where it is confirmed that there is no reactor R in which the adsorbent has a high temperature and the pressure in the adsorption chamber is not sufficiently reduced, the negative determination is made in S71, the processing proceeds to S72, and the vacuum control valves 53 for CO₂ recovery of all the reactors R are controlled to be closed. Next, similarly to S61 to S67 in the first FSA, after the adsorbent of each reactor R is cooled down to normal temperature, the pressure in the adsorption chamber is recovered, and the DAC apparatus 100 is stopped.

FIG. 13 is a flowchart illustrating an example of the third FSA processing performed by the controller 10. The third FSA is taken when the closed failure of the pressure recovery control valve 8 is detected in the pressure-recovering step.

As illustrated in FIG. 13, in the third FSA processing, first in S80, the controller 10 controls and stops the vacuum pump 4 for deaeration (or the vacuum pump 5 for CO₂ recovery). Then, in S81, the vacuum control valves 53 for CO₂recovery and the vacuum control valves 43 for deaeration of all the reactors R are controlled to be closed. Next, similarly to S61 to S65 in the first FSA and the second FSA, after the adsorbent of each reactor R is cooled down to normal temperature, the pressure in the adsorption chamber is recovered, and the atmospheric control valves 1 and 2 are controlled to be opened.

Next, in S82, the atmospheric control valves 1 and 2 are controlled to be closed for the normal reactor Rn in which there is no closed failure in the pressure recovery control valve 8 and the atmospheric control valves 1 and 2 are opened first in S65. Next, in S83, the vacuum control valves 43 for deaeration of a failed reactor Rf, in which the closed failure of the pressure recovery control valve 8 is occurring, and of a normal reactor Rn are controlled to be opened (in a case where the vacuum pump 5 for CO₂recovery is stopped in S80, the vacuum control valve 53 for CO₂recovery is controlled to be opened). Next, in S84, the pressure recovery control valve 8 of the normal reactor Rn is controlled to be opened. In pressure-recovering processing of S82 to S84, the pressure in the adsorption chamber of the failed reactor Rf is recovered through the pressure recovery control valve 8 and the vacuum piping 40 for deaeration of the normal reactor Rn (the vacuum piping 50 for CO₂ recovery, in the case where the vacuum pump 5 for CO₂ recovery is stopped in S80).

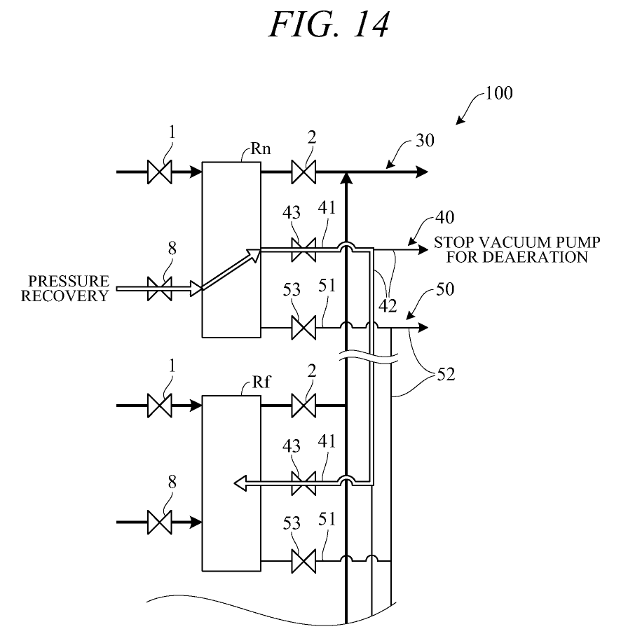

FIG. 14 is a diagram for describing the pressure-recovering processing in S82 to S84. In the example of FIG. 14, the vacuum pump 4 for deaeration is stopped. With regard to the normal reactor Rn, the atmospheric control valves 1 and 2 and the vacuum control valve 53 for CO₂recovery are closed, and the pressure recovery control valve 8 and the vacuum control valve 43 for deaeration are open. With regard to the failed reactor Rf, the atmospheric control valves 1 and 2 and the vacuum control valve 53 for CO₂ recovery are closed, the pressure recovery control valve 8 is closed due to the closed failure, and the vacuum control valve 43 for deaeration is open. In this case, the atmosphere that has flowed in from the pressure recovery control valve 8 of the normal reactor Rn flows into the adsorption chamber of the failed reactor Rf through the vacuum piping 40 for deaeration. Thus, the pressure in the adsorption chamber of the failed reactor Rf is recovered.

Next, in S85, it is determined whether the pressure P that has been detected by the pressure sensor 12 of the failed reactor Rf and the pressure P that has been detected by the pressure sensor 12 of the normal reactor Rn are equal to or higher than the predetermined pressure P3. S85 is repeated until an affirmative determination is made. The pressure of the failed reactor Rf and the pressure of the normal reactor Rn are recovered, and in a case where the pressure P becomes equal to or higher than the predetermined pressure P3, the affirmative determination is made in S85, and the processing proceeds to S86. In S86, the failed reactor Rf and the normal reactor Rn are controlled in such a manner that the vacuum control valve 43 for deaeration is closed (in the case where the vacuum pump 5 for CO₂recovery is stopped in S80, the vacuum control valve 53 for CO₂ recovery is closed), the pressure recovery control valve 8 is closed, and the atmospheric control valves 1 and 2 are open. Next, in S87, it is determined whether the processing of S65 has been completed in all the reactors R and the atmospheric control valves 1 and 2 are open. S87 is repeated until an affirmative determination is made. In a case where the affirmative determination is made in S87, the processing proceeds to S88, the fan 3, the vacuum pumps 4 and 5, and the heat exchanger 7 are stopped, and the DAC apparatus 100 is stopped.

In this manner, failure detection for each reactor R is conducted in each step. After the adsorbent of each reactor R is cooled down to normal temperature as necessary, the atmosphere is introduced into the adsorption chamber, and the pressure is recovered. Then, appropriate FSA for stopping the DAC apparatus 100 is taken, so that the oxidation deterioration of the adsorbent can be prevented.

According to the embodiments of the present invention, the following operation and effects are achievable.

(1) The DAC apparatus 100 includes: the reactor R in which an adsorbent for adsorbing or absorbing CO₂ is provided; the atmospheric control valves 1 and 2, which open the reactor R to the atmosphere or seal the reactor R from the atmosphere; the vacuum pump 4 connected with the reactor R through the vacuum piping 40, and the vacuum pump 5 connected with the reactor R through the vacuum piping 50; the vacuum control valve 43 provided on the vacuum piping 40, and the vacuum control valve 53 provided on the vacuum piping 50; the heat exchanger 7, which heats the adsorbent; the pressure sensor 12, which detects pressure P of the reactor R; and the controller 10 configured to control the atmospheric control valves 1 and 2, the vacuum control valves 43 and 53, the vacuum pumps 4 and 5, and the heat exchanger 7 to alternately perform an adsorption step and a desorption step, the adsorption step circulating the atmosphere into the reactor R, and adsorbing CO₂ in the atmosphere to the adsorbent, the desorption step depressurizing the reactor R, heating the adsorbent, and desorbing CO₂ from the adsorbent (FIGS. 1 and 2).

When starting the desorption step, the controller 10 controls the atmospheric control valves 1 and 2, the vacuum control valves 43 and 53, and the vacuum pumps 4 and 5 to depressurize the reactor R, and then determines whether the atmospheric control valves 1 and 2 are normal, based on the pressure that has been detected by the pressure sensor 12 before heating the adsorbent (S20 to S25 in FIG. 6). In this manner, before the desorption step starts, by conducting failure detection for the vacuum system including the atmospheric control valves 1 and 2, it becomes possible to prevent the adsorbent from being exposed to the atmosphere when the temperature rises, so that the oxidation deterioration of the adsorbent can be prevented.

(2) After the desorption step starts, the controller 10 further determines whether the vacuum control valve 53 is normal, based on the pressure P that has been detected by the pressure sensor 12 (S30 to S32 in FIG. 7). In this manner, after the desorption step starts, a failure in the vacuum system including the vacuum control valve 53 for CO₂recovery is detected, so that the oxidation deterioration of the adsorbent can be more certainly prevented.

(3) The reactor R includes the reactor Ra and the reactor Rb, and while the desorption step is being performed in the reactor Ra, the desorption step starts in the reactor Rb (FIGS. 3 and 8). The controller 10 further determines whether the vacuum control valve 53a of the reactor Ra is abnormal, based on the pressure that has been detected by the pressure sensor 12b while the desorption step is being performed in the reactor Rb (S30 to S32, S34, and S36 to S37 in FIG. 7). That is, after the desorption step starts in the own reactor Rb, the failure in the vacuum system including the vacuum control valve 53bfor CO₂recovery of another reactor Ra is detected, based on pressure Pb of the own reactor Rb immediately after the desorption step of another reactor Ra ends and the pressure recovery is started. In this manner, in consideration of the operation schedule of the plurality of reactors R, the failure in the vacuum system can be efficiently detected.

(4) The DAC apparatus 100 further includes the temperature sensor 11, which detects the temperature of the adsorbent (FIGS. 1 and 2). After the adsorption step starts, the controller 10 further determines whether the atmospheric control valves 1 and 2 are normal, based on the temperature T that has been detected by the temperature sensor 11 (S10 to S12 in FIG. 5). In this manner, after the adsorption step starts, the failure in the atmospheric control valves 1 and 2 and the fan 3 is detected to detect an adsorption abnormality in the adsorption step, so that the reliability of the DAC apparatus 100 can be improved.

The above embodiment can be combined as desired with one or more of the aforesaid modifications. The modifications can also be combined with one another.

According to the present invention, it becomes possible to prevent the oxidation deterioration of the adsorbent.

Above, while the present invention has been described with reference to the preferred embodiments thereof, it will be understood, by those skilled in the art, that various changes and modifications may be made thereto without departing from the scope of the appended claims.

1. A DAC apparatus configured to recover CO₂ in the atmosphere, comprising:
an adsorption chamber provided with an adsorbent for adsorbing or absorbing CO₂;
an atmospheric control valve configured to open the adsorption chamber to the atmosphere or seal the adsorption chamber from the atmosphere;
a vacuum pump connected with the adsorption chamber through vacuum piping;
a vacuum control valve provided on the vacuum piping;
a heating device configured to heat the adsorbent;
a pressure sensor configured to detect a pressure of the adsorption chamber; and
a controller configured to control the atmospheric control valve, the vacuum control valve, the vacuum pump, and the heating device to alternately perform an adsorption step and a desorption step, the adsorption step circulating the atmosphere into the adsorption chamber and adsorbing CO₂ in the atmosphere to the adsorbent, the desorption step depressurizing the adsorption chamber, heating the adsorbent, and desorbing CO₂ from the adsorbent, wherein
the controller controls the atmospheric control valve, the vacuum control valve, and the vacuum pump to depressurize the adsorption chamber when starting the desorption step, and then determines whether the atmospheric control valve is normal based on the pressure detected by the pressure sensor before heating the adsorbent.

2. The DAC apparatus according to claim 1, wherein
the controller further determines whether the vacuum control valve is normal based on the pressure detected by the pressure sensor after starting the desorption step.

3. The DAC apparatus according to claim 2, wherein
the adsorption chamber includes a first adsorption chamber and a second adsorption chamber, the desorption step being started in the second adsorption chamber while the desorption step is being performed in the first adsorption chamber, wherein
the controller further determines whether the vacuum control valve of the first adsorption chamber is abnormal based on the pressure detected by the pressure sensor while the desorption step is being performed in the second adsorption chamber.

4. The DAC apparatus according to claim 1, further comprising:
a temperature sensor configured to detect the temperature of the adsorbent, wherein
the controller further determines whether the atmospheric control valve is normal based on the temperature detected by the temperature sensor after starting the adsorption step.
